(19) United States
(12) Patent Application Publication
(10) Pub. No.: US 2020/0086764 A1
(43) Pub. Date: Mar. 19, 2020

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Yoshitaka Mimura, Wako-shi (JP); Masahiko Asakura, Wako-shi (JP); Hironori Takano, Wako-shi (JP); Junichi Maruyama, Wako-shi (JP); Naotaka Kumakiri, Wako-shi (JP)

(21) Appl. No.: 16/468,306

(22) PCT Filed: Dec. 22, 2016
(86) PCT No.: PCT/JP2016/088467

§ 371 Date: Jun. 11, 2019

(51) Int. Cl. B60N 2/00; G05D 1/00; B60W 30/18; B60W 10/04; B60W 10/20; B60N 2/02; B60N 2/01

(52) U.S. Cl. CPC B60N 2/002; G05D 1/0088; B60W 30/18; B60W 10/04; G05D 2201/0213; B60N 2/0244; B60N 2/01; B60W 2710/20; B60W 2720/106; B60W 10/20

(57) ABSTRACT

A vehicle control system includes: seats provided in a vehicle; an occupant detection unit that detects an arrangement or a state of occupants in a vehicle cabin of the vehicle; and a seat arrangement control unit that performs seat arrangement control of changing at least one of a posture, a position, and a direction of the seats according to the arrangement or the state of the occupants detected by the occupant detection unit.

### TECHNICAL FIELD

The present invention relates to a vehicle control system, a vehicle control method, and a vehicle control program.

### BACKGROUND ART

Conventionally, an apparatus configured to allow the arrangement of vehicle seats to be changed is known (for example, see Patent Literature 1).

### CITATION LIST

### Patent Literature

[Patent Literature 1] Japanese Unexamined Patent Application, First Publication No. 2013-086577

### SUMMARY OF INVENTION

### Technical Problem

However, the apparatus related to the conventional technique performs control so as to allow long baggage to be loaded into a vehicle but the other matters are not taken into consideration.

The present invention has been made in view of such a circumstance, and one object thereof is to provide a vehicle control system, a vehicle control method, and a vehicle control program which enable a vehicle interior space to be used effectively according to an arrangement or a state of occupants.

### Solution to Problem

An invention according to claim 1 is a vehicle control system including: seats provided in a vehicle; an occupant detection unit that detects an arrangement or a state of occupants in a vehicle cabin of the vehicle; and a seat arrangement control unit that performs seat arrangement control of changing at least one of a posture, a position, and a direction of the seats according to the arrangement or the state of the occupants detected by the occupant detection unit.

An invention according to claim 2 is the vehicle control system according to claim 1, which further includes an automated driving controller that executes automated driving of automatically controlling at least one of acceleration/deceleration and steering of the vehicle, and in which the seat arrangement control unit performs the seat arrangement control when automated driving is executed by the automated driving controller.

An invention according to claim 3 is the vehicle control system according to claim 1 or 2, in which the seat arrangement control unit performs the seat arrangement control so that the bodies of at least two of a plurality of occupants face each other when a state in which a plurality of occupants are talking to each other is detected by the occupant detection unit.

An invention according to claim 4 is the vehicle control system according to any one of claims 1 to 3, in which the occupant detection unit can detect a degree of exposure of an occupant to direct sunlight, and the seat arrangement control unit performs the seat arrangement control so as to avoid direct sunlight exposure of the occupant when a state in which the occupant is exposed to a predetermined amount or more of direct sunlight is detected by the occupant detection unit.

An invention according to claim 5 is the vehicle control system according to any one of claims 1 to 4, in which the seat arrangement control unit performs the seat arrangement control so that bodies of at least two of a plurality of occupants do not face each other when the occupant detection unit determines that a plurality of occupants require a private space.

An invention according to claim 6 is the vehicle control system according to claim 5, in which the occupant detection unit determines that at least one of a plurality of occupants requires a private space when a plurality of occupants are riding in a carpool.

An invention according to claim 7 is the vehicle control system according to any one of claims 1 to 6, which further includes an imaging unit that captures a vehicle exterior scene, and in which the seat arrangement control unit performs the seat arrangement control so that bodies of occupants face a landmark when the landmark is included in the vehicle exterior scene captured by the imaging unit.

An invention according to claim 8 is a vehicle control method for causing a computer mounted in a vehicle including seats to execute: detecting an arrangement or a state of occupants in a vehicle cabin of the vehicle; and performing seat arrangement control of changing at least one of a posture, a position, and a direction of the seats according to the arrangement or the state of the occupants.

An invention according to claim 9 is a vehicle control program for causing a computer mounted in a vehicle including seats to execute: detecting an arrangement or a state of occupants in a vehicle cabin of the vehicle; and performing seat arrangement control of changing at least one of a posture, a position, and a direction of the seats according to the arrangement or the state of the occupants.

### Advantageous Effects of Invention

According to the invention according to claims 1, 8, and 9, it is possible to effectively use a vehicle interior space.

According to the invention according to claim 2, it is possible to effectively use a vehicle interior space during automated driving.

According to the invention according to claim 3, it is possible to allow a plurality of occupants to talk easily.

According to the invention according to claim 4, it is possible to avoid direct sunlight from being exposed to occupants.

According to the invention according to claim 5, it is possible to secure private spaces for a plurality of occupants.

According to the invention according to claim 6, it is possible to secure private spaces for a plurality of carpool occupants.

According to the invention according to claim 7, it is possible to allow occupants to see a landmark easily.

### BRIEF DESCRIPTION OF DRAWINGS

FIG. 1 is a block diagram of a vehicle system 1 to which a vehicle control system according to a first embodiment is applied.

FIGS. 2A and 2B are detailed diagrams of a carpool control unit 164 and a landmark visual recognition control unit 168 illustrated in FIG. 1.

FIG. 3 is a diagram illustrating how the relative position or the direction of a host vehicle M with respect to a traveling lane L1 is recognized by a host vehicle position recognition unit 122.

FIG. 4 is a diagram illustrating how a target trajectory is generated on the basis of a recommended lane.

FIG. 5 is a flowchart illustrating an example of the flow of an automated driving mode selection process executed by an automated driving control unit 100.

FIG. 6 is a flowchart illustrating an example of the flow of processes executed by the automated driving control unit 100 in order to effectively use a vehicle interior space during automated driving.

FIGS. 7A and 7B are diagrams illustrating an example of the arrangement or the state of occupants detected by an occupant detection unit 160 and the seat arrangement control executed in step S106 of FIG. 6.

FIG. 8 is a flowchart illustrating another example of the flow of processes executed by the automated driving control unit 100 in order to effectively use a vehicle interior space during automated driving.

FIGS. 9A and 9B are diagrams illustrating another example of the arrangement or the state of occupants detected by an occupant detection unit 160 and the seat arrangement control executed in step S206 of FIG. 8.

FIG. 10 is a flowchart illustrating another example of the flow of processes executed by the automated driving control unit 100 in order to effectively use a vehicle interior space during automated driving.

FIGS. 11A and 11B are diagrams illustrating another example of the arrangement or the state of occupants detected by an occupant detection unit 160 and the seat arrangement control executed in step S306 of FIG. 10.

FIG. 12 is a diagram illustrating an example of contents output to the vehicle outside.

FIG. 13 is a diagram illustrating an example of the movement of character strings indicated by images 300F and 300L.

FIG. 14 is a diagram for describing the details of ride candidate determination by a ride candidate determination unit 166.

FIG. 15 is a flowchart illustrating another example of the flow of processes executed by the automated driving control unit 100 in order to effectively use a vehicle interior space during automated driving.

FIG. 16 is a flowchart illustrating another example of the flow of processes executed by the automated driving control unit 100 in order to effectively use a vehicle interior space during automated driving.

FIGS. 17A and 17B are diagrams illustrating another example of the arrangement or the state of occupants detected by an occupant detection unit 160 and the seat arrangement control executed in step S506 of FIG. 16.

FIG. 18 is a diagram illustrating an example of a positional relation between a host vehicle M and a landmark 600 when a landmark is included in a vehicle exterior scene captured by a camera 10.

### DESCRIPTION OF EMBODIMENTS

Hereinafter, an embodiment of a vehicle control system, a vehicle control method, and a vehicle control program according to the present invention will be described with reference to the drawings.

### First Embodiment

### [Overall Configuration]

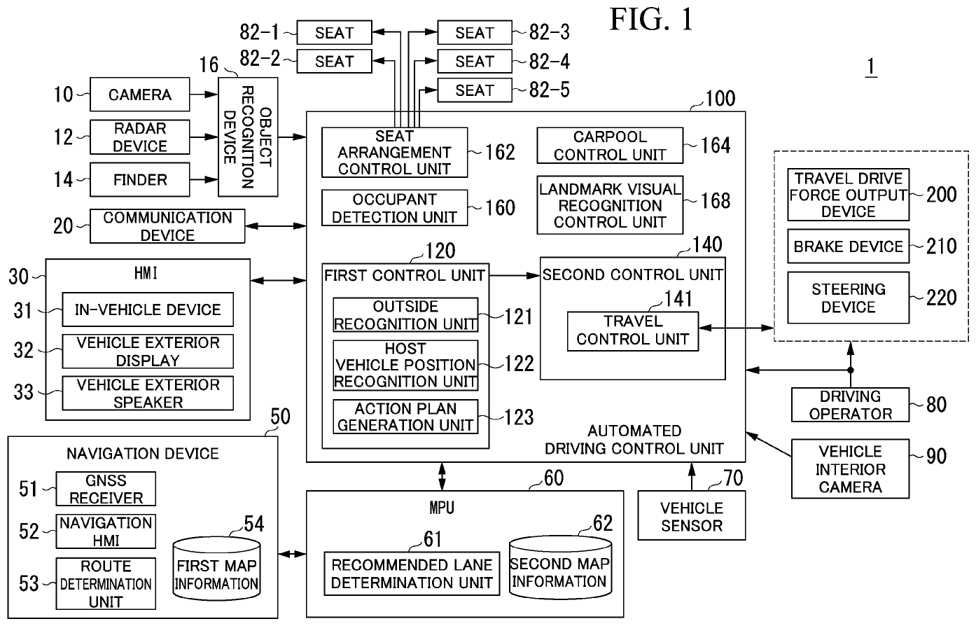

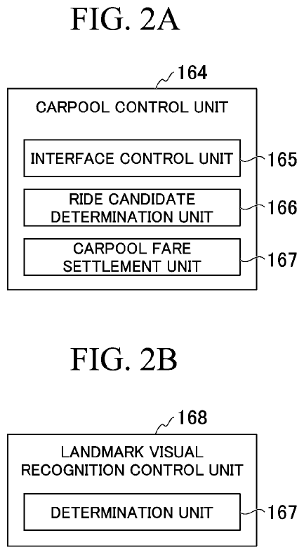

FIG. 1 is a block diagram of a vehicle system 1 to which a vehicle control system according to a first embodiment is applied. FIGS. 2A and 2B are detailed diagrams of a carpool control unit 164 and a landmark visual recognition control unit 168 illustrated in FIG. 1. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. An electric motor operates using electric power generated by a generator connected to an internal combustion engine or electric power discharged by secondary batteries or fuel-cell batteries.

The vehicle system 1 includes, for example, a camera 10, a radar apparatus 12, a finder 14, an object recognition apparatus 16, a communication device 20, a human machine interface (HMI) 30, a navigation apparatus 50, a micro-processing unit (MPU) 60, a vehicle sensor 70, a driving operator 80, a vehicle interior camera 90, an automated driving control unit 100, a travel drive force output device 200, a brake device 210, and a steering device 220. These apparatuses and devices are connected to each other by a multiplex communication line such as a controller area network (CAN) communication line, a serial communication line, a wireless communication network, and the like. Moreover, the components illustrated in FIG. 1 are examples only, and some of these components may be omitted and other components may be added.

The vehicle system 1 to which the vehicle control system of the first embodiment is applied includes, for example, seats 82-1 to 82-5 in addition to the above-described components. The seats 82-1 to 82-5 include a driver's seat 82-1 on which a driver sits and occupant seats 82-2 to 82-5 on which occupants of a host vehicle M other than the driver sit. The seats 82-1 to 82-5 include an actuator that changes at least one of the posture, the position, and the direction of the seats 82-1 to 82-5.

The camera 10 is, for example, a digital camera which uses a solid-state imaging device such as a charge coupled device (CCD) or a complementary metal oxide semiconductor (CMOS). One or a plurality of cameras 10 are attached to arbitrary positions on a vehicle (hereinafter referred to as a host vehicle M) in which the vehicle system 1 is mounted. When capturing images on the side in front, the camera 10 is attached to an upper part of a front windshield or a back surface of a rear-view mirror. The camera 10, for example, captures the images around the host vehicle M repeatedly and periodically. The camera 10 may be a stereo camera.

The radar apparatus 12 emits radio waves such as millimeter waves to the surroundings of the host vehicle M and detects radio waves (reflected waves) reflected from an object to detect at least the position (the distance and direction) of the object. One or a plurality of radar apparatuses 12 are attached to arbitrary positions on the host vehicle M. The radar apparatus 12 may detect the position and the speed of an object according to a frequency modulated continuous wave (FM-CW) method.

The finder 14 is a light detection and ranging or laser imaging detection and ranging (LIDAR) device that measures scattering light of emitted light and detects the distance to an object. One or a plurality of finders 14 are attached to arbitrary positions on the host vehicle M.

The object recognition apparatus 16 performs sensor fusion processing on detection results obtained by some or all of the camera 10, the radar apparatus 12, and the finder 14 to recognize the position, the kind, the speed, and the like of an object. The object recognition apparatus 16 outputs the recognition results to the automated driving control unit 100.

The communication device 20, for example, communicates with other vehicles present around the host vehicle M using a cellular network, a Wi-Fi network, Bluetooth (registered trademark), a dedicated short range communication (DSRC), or the like, or communicates with various servers via a wireless base station.

The HMI 30 presents various pieces of information to an occupant of the host vehicle M and receives input operations of the occupant. The HMI 30 includes an in-vehicle device 31, for example. The in-vehicle device 31 is, for example, various display devices, speakers, buzzers, touch panels, switches, keys, and the like. Moreover, the HMI 30 presents information to the vehicle outside. In this case, the HMI 30 includes, for example, a vehicle exterior display 32, a vehicle exterior speaker 33, and the like. The vehicle exterior speaker 33 outputs sound to a predetermined range of the vehicle outside. The vehicle exterior speaker 33 may output sound with directivity in a predetermined direction.

The navigation apparatus 50 includes, for example, a global navigation satellite system (GNSS) receiver 51, a navigation HMI 52, and a route determination unit 53, and stores first map information 54 in a storage device such as a hard disk drive (HDD) or a flash memory. The GNSS receiver specifies the position of the host vehicle M on the basis of signals received from GNSS satellites. The position of the host vehicle M may be specified or complemented by an inertial navigation system (INS) which uses the output of the vehicle sensor 70. The navigation HMI 52 includes a display device, a speaker, a touch panel, keys, and the like. The navigation HMI 52 may be partially or entirely shared with the HMI 30. For example, the route determination unit 53 determines a route from the position (or an input arbitrary position) of the host vehicle M specified by the GNSS receiver 51 to a destination input by an occupant using the navigation HMI 52 by referring to the first map information 54. The first map information 54 is information in which a road shape is represented by links indicating roads and nodes connected by links. The first map information 54 may include the curvature of a road, point of interest (POI) information, and the like. The route determined by the route determination unit 53 is output to the MPU 60. Moreover, the navigation apparatus 50, for example, may perform route guidance using the navigation HMI 52 on the basis of the route determined by the route determination unit 53. The navigation apparatus 50 may be realized by the functions of a terminal device such as a smartphone or a tablet terminal held by a user. Moreover, the navigation apparatus 50 may transmit a present position and a destination to a navigation server via the communication device 20 and acquire a route returned from the navigation server.

The MPU 60 functions as a recommended lane determination unit 61, for example, and stores second map information 62 in a storage device such as a HDD or a flash memory. The recommended lane determination unit 61 divides the route provided from the navigation apparatus 50 into a plurality of blocks (for example, the route may be partitioned every 100 [m] in relation to a vehicle traveling direction) and determines a recommended lane for each block by referring to the second map information 62. The recommended lane determination unit 61 determines a certain lane from the left that the host vehicle travels in. When a branching point, a junction point, and the like are present on a route, the recommended lane determination unit 61 determines a recommended lane so that the host vehicle M can travel along a reasonable route for proceeding to a branch destination.

The second map information 62 is map information with higher accuracy than the first map information 54. The second map information 62 includes, for example, information on the center of a lane or information on the boundaries of a lane. Moreover, the second map information 62 may include road information, traffic regulation information, address information (address and postal codes), facility information, telephone number information, and the like. The road information includes information indicating the type of a road such as an expressway, a toll road, a national highway, or a county or state road, and information such as the number of lanes on a road, the width of each lane, a gradient of a road, the position of a road (3-dimensional coordinates including the latitude, the longitude, and the height), the curvature of a lane, and the positions of merging and branching points of lanes, and signs provided on a road. The second map information 62 may be updated as necessary by accessing other devices using the communication device 20.

The vehicle sensor 70 includes a vehicle speed sensor that detects the speed of the host vehicle M, an acceleration sensor that detects an acceleration, a yaw-rate sensor that detects an angular speed about a vertical axis, an azimuth sensor that detects the direction of the host vehicle M, and the like.

The driving operator 80 includes, for example, an acceleration pedal, a brake pedal, a shift lever, a steering wheel, and other operators. Sensors that detect an amount of operation, the presence of an operation, and the like are attached to the driving operator 80, and the detection results are output to any one or both of the automated driving control unit 100 or the travel drive force output device 200, the brake device 210, and the steering device 220.

The vehicle interior camera 90 captures the image of occupants in the vehicle cabin of the host vehicle M. Moreover, the vehicle interior camera 90 includes means for acquiring vehicle interior sound such as a microphone, for example. The image captured by the vehicle interior camera 90 and the vehicle interior sound acquired by the vehicle interior camera 90 are output to the automated driving control unit 100.

The automated driving control unit 100 includes, for example, a first control unit 120, a second control unit 140, an occupant detection unit 160, a seat arrangement control unit 162, a carpool control unit 164, and a landmark visual recognition control unit 168. The first control unit 120, the second control unit 140, the occupant detection unit 160, the seat arrangement control unit 162, the carpool control unit 164, and the landmark visual recognition control unit 168 each are realized when a processor such as a central processing unit (CPU) or the like executes a program (software). Moreover, some or all of the functional units of the first control unit 120, the second control unit 140, the occupant detection unit 160, the seat arrangement control unit 162, the carpool control unit 164, and the landmark visual recognition control unit 168 may be realized by hardware such as a large scale integration (LSI), an application specific integrated circuit (ASIC), or a field-programmable gate array (FPGA) and may be realized by the cooperation of software and hardware.

The first control unit 120 includes, for example, an outside recognition unit 121, a host vehicle position recognition unit 122, and an action plan generation unit 123.

The outside recognition unit 121 recognizes the position of a neighboring vehicle and conditions such as the speed, the acceleration, or the like on the basis of information input directly from the camera 10, the radar apparatus 12, and the finder 14 or via the object recognition apparatus 16. The position of the neighboring vehicle may be represented by a representative point such as the center of gravity or a corner of the neighboring vehicle and may be represented by a region represented by the contour of the neighboring vehicle. The “state” of the neighboring vehicle may include the acceleration or a jerk of the neighboring vehicle or an “action state” (for example, whether the neighboring vehicle has changed or is trying to change lanes). Moreover, the outside recognition unit 121 may recognize the position of a guard rail, a post, a parked vehicle, a pedestrian, and other objects in addition to a neighboring vehicle.

The host vehicle position recognition unit 122, for example, recognizes a lane (a traveling lane) in which the host vehicle M is traveling and the relative position and the direction of the host vehicle M in relation to the traveling lane. For example, the host vehicle position recognition unit 122 recognizes the traveling lane by comparing a pattern (for example, an arrangement of solid lines and broken lines) of lane marks obtained from the second map information 62 and a pattern of lane marks around the host vehicle M recognized from the images captured by the camera 10. In the recognition, the position of the host vehicle M acquired from the navigation apparatus 50 and the processing results of the INS may be also taken into consideration.

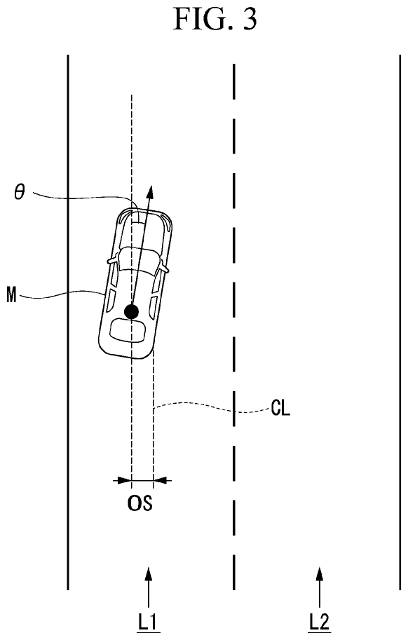

The host vehicle position recognition unit 122, for example, recognizes the position and the direction of the host vehicle M in relation to the traveling lane. FIG. 3 is a diagram illustrating how the relative position and the direction of the host vehicle M in relation to the traveling lane L1 are recognized by the host vehicle position recognition unit 122. For example, the host vehicle position recognition unit 122, for example, recognizes an offset OS from a traveling lane center CL of a reference point (for example, the center of gravity) of the host vehicle M and an angle θ between the traveling direction of the host vehicle M and an extension line of the traveling lane center CL as the relative position and the direction of the host vehicle M in relation to the traveling lane L1. Instead of this, the host vehicle position recognition unit 122 may recognize the position or the like of a reference point of the host vehicle M in relation to any one of side ends of the host lane L1 as the relative position of the host vehicle M in relation to the traveling lane. The relative position of the host vehicle M recognized by the host vehicle position recognition unit 122 is provided to the recommended lane determination unit 61 and the action plan generation unit 123.

The action plan generation unit 123 determines events executed sequentially in automated driving so that the host vehicle travels along a recommended lane determined by the recommended lane determination unit 61 and can cope with the surrounding situation of the host vehicle M. Examples of the event include a constant speed travel event in which a vehicle travels in the same traveling lane at a constant speed, a trailing travel event in which a vehicle follows a preceding vehicle, a lane changing event, a merging event, a diverging event, an emergency stop event, and a handover event for ending automated driving and switching to manual driving. Moreover, during execution of these events, an avoidance action may be planned on the basis of a surrounding situation (the presence of a neighboring vehicle or a pedestrian or narrowing of lanes due to road construction) of the host vehicle M.

The action plan generation unit 123 generates a target trajectory along which the host vehicle M will travel in the future. The target trajectory includes, for example, a speed element. For example, the target trajectory is generated as a set of target positions (trajectory points) that are to be reached at a plurality of future reference time points which are set at intervals of predetermined sampling periods (for example, approximately every 0.x [sec]). Therefore, when the width between trajectory points is large, it indicates that a vehicle travels at high speed in a segment between the trajectory points.

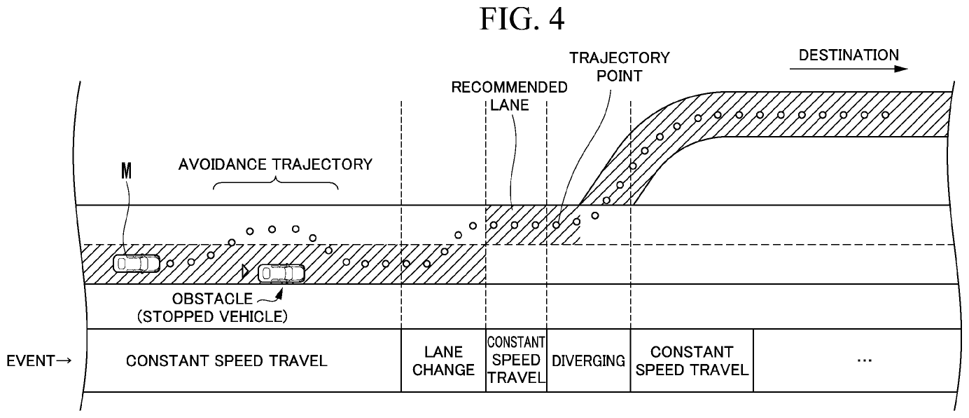

FIG. 4 is a diagram illustrating how a target trajectory is generated on the basis of a recommended lane. As illustrated in the drawing, a recommended lane is set such that a vehicle can easily travel along the route to a destination. When a vehicle arrives at a position a predetermined distance before (which may be determined depending on an event type) a switching position of the recommended lane, the action plan generation unit 123 activates a lane changing event, a diverging event, a merging event, or the like. When a need to avoid an obstacle occurs during execution of each event, an avoidance trajectory is generated as illustrated in the drawing.

The action plan generation unit 123, for example, generates a plurality of candidates for target trajectories and selects an optimal target trajectory at that time point on the basis of the viewpoint of safety and efficiency.

The second control unit 140 includes a travel control unit 141. The travel control unit 141 controls the travel drive force output device 200, the brake device 210, and the steering device 220 so that the host vehicle M passes along the target trajectory generated by the action plan generation unit 123 at a scheduled time.

The travel drive force output device 200 outputs a travel drive force (torque) for a vehicle to travel to driving wheels. The travel drive force output device 200 includes a combination of an internal combustion engine, an electric motor, and a transmission and an ECU that controls these components. The ECU controls the above-mentioned components according to information input from the travel control unit 141 or information input from the driving operator 80.

The brake device 210 includes, for example, a brake caliper, a cylinder that delivers hydraulic pressure to the brake caliper, an electric motor that generates hydraulic pressure in the cylinder, and a brake ECU. The brake ECU controls the electric motor according to information input from the travel control unit 141 or information input from the driving operator 80 so that brake torque corresponding to a braking operation is output to each wheel. The brake device 210 may include a backup mechanism that delivers hydraulic pressure generated by an operation of a brake pedal included in the driving operator 80 to a cylinder via a master cylinder. The brake device 210 is not limited to the above-described configuration and may be an electrically-controlled hydraulic-pressure brake device that controls an actuator according to information input from the travel control unit 141 and delivers hydraulic pressure of the master cylinder to a cylinder.

The steering device 220 includes, for example, a steering ECU and an electric motor. The electric motor, for example, applies a force to a rack-and-pinion mechanism to change the direction of a steering wheel. The steering ECU drives an electric motor according to the information input from the travel control unit 141 or the information input from the driving operator 80 to change the direction of the steering wheel.

### [Seat Arrangement Control]

Hereinafter, seat arrangement control according to the embodiment will be described. The occupant detection unit 160 detects the arrangement and the state of occupants on the basis of the image of the occupants captured by the vehicle interior camera 90 and the vehicle interior sound acquired by the vehicle interior camera 90.

The seat arrangement control unit 162 performs the seat arrangement control of changing at least one of the posture, the position, and the direction of some or all of the seats 82-1 to 82-5 according to the arrangement or the state of occupants detected by the occupant detection unit 160.

The carpool control unit 164 executes carpool control to be described in detail later. The landmark visual recognition control unit 168 executes landmark visual recognition control to be described in detail later.

The automated driving control unit 100 including the first control unit 120 and the second control unit 140 functions as an automated driving controller that executes automated driving of automatically controlling at least one of acceleration/deceleration and steering of the host vehicle M. The automated driving executed by the automated driving control unit 100 includes, for example, a first mode, a second mode, and a third mode.

A first mode of automated driving is a mode in which the degree of automated driving is the highest among the modes. When the first mode of automated driving is executed, since all vehicle control operations such as complex merging control are performed automatically, no obligations related to driving as required for drivers are incurred. For example, a driver does not need to monitor the surroundings and the state of the host vehicle M (no surrounding monitoring obligations as required for drivers are incurred). Moreover, a driver does not need to perform driving-related operations on an acceleration pedal, a brake pedal, a steering wheel, and the like (no driving operation obligation as required for drivers are incurred), and may concentrate on something other than vehicle driving. That is, during execution of the first mode of automated driving, since a driving operation or the like is not required for drivers, no problem occurs during seat arrangement control of changing at least one of the posture, the position, and the direction of the driver's seat 82-1 being performed. Therefore, during execution of the first mode of automated driving, the seat arrangement control for the driver's seat 82-1 is performed by the seat arrangement control unit 162.

A second mode of automated driving is a mode in which the degree of automated driving is the next highest after the first mode. When the second mode of automated driving is executed, although all vehicle control operations are basically performed automatically, a driver may be responsible for operation of the driving of the host vehicle M depending on a scene (the obligations related to vehicle driving are increased as compared to the first mode). Due to this, a driver needs to monitor the surroundings and the state of the host vehicle M and pay attention to driving of the host vehicle M (the obligations related to vehicle driving are increased as compared to the first mode). That is, during execution of the second mode of automated driving, since a driving operation or the like may be required for drivers, the seat arrangement control for the driver's seat 82-1 is not performed by the seat arrangement control unit 162.

A third mode of automated driving is a mode in which the degree of driving assistance is the next highest after the second mode. When the third mode of automated driving is executed, a driver needs to check the HMI 30 depending on a scene (the obligations related to vehicle driving are increased as compared to the second mode). In the third mode, when a lane changing timing is notified to a driver, and the driver performs an operation of issuing a lane changing instruction to the HMI 30, a lane changing operation is performed automatically. Due to this, the driver needs to monitor the surroundings and the state of the host vehicle M (the obligations related to vehicle driving are increased as compared to the second mode). That is, during execution of the third mode of automated driving, since a driving operation or the like is required for drivers, the seat arrangement control for the driver's seat 82-1 is not performed by the seat arrangement control unit 162.

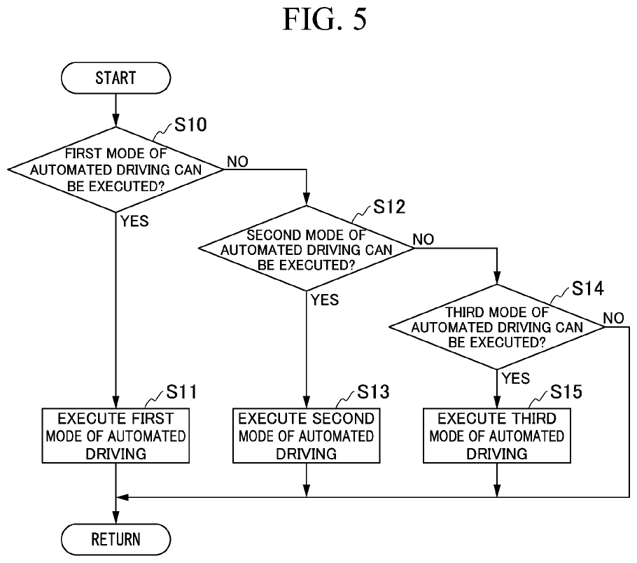

FIG. 5 is a flowchart illustrating an example of the flow of an automated driving mode selection process executed by the automated driving control unit 100. The process of this flowchart is executed repeatedly using a predetermined cycle, for example. First, the automated driving control unit 100 determines whether the first mode of automated driving can be executed (step S10). When the first mode of automated driving can be executed, the automated driving control unit 100 executes the first mode of automated driving (step S11). On the other hand, when the first mode of automated driving cannot be executed, the automated driving control unit 100 determines whether the second mode of automated driving can be executed (step S12). When the second mode of automated driving can be executed, the automated driving control unit 100 executes the second mode of automated driving (step S13). On the other hand, when the second mode of automated driving cannot be executed, the automated driving control unit 100 determines whether the third mode of automated driving can be executed (step S14). When the third mode of automated driving can be executed, the automated driving control unit 100 executes the third mode of automated driving (step S15). On the other hand, when the third mode of automated driving cannot be executed, the process of one routine of this flowchart ends.

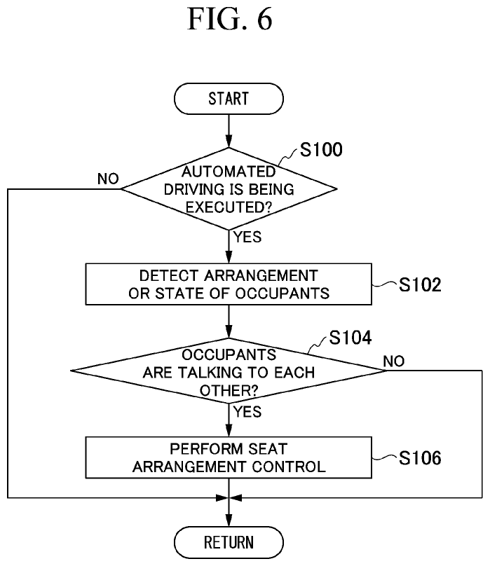

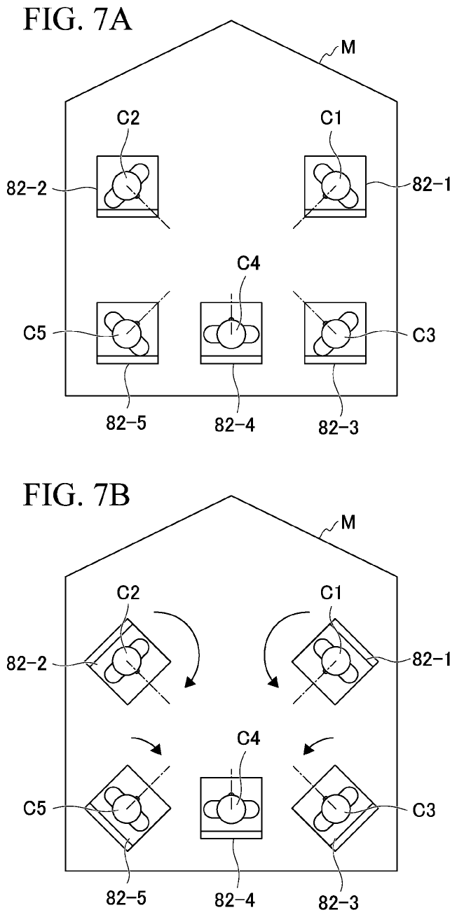

FIG. 6 is a flowchart illustrating an example of the flow of processes executed by the automated driving control unit 100 in order to effectively use the vehicle interior space during automated driving. FIGS. 7A and 7B are diagrams illustrating an example of the arrangement or the state of occupants detected by the occupant detection unit 160 and the seat arrangement control executed in step S106 of FIG. 6.

The process of the flowchart illustrated in FIG. 6 is executed repeatedly at a predetermined period, for example. First, the automated driving control unit 100 determines whether automated driving is being executed (step S100). Specifically, the automated driving control unit 100 determines whether automated driving is being executed in any one mode of the first mode, the second mode, and the third mode. When the automated driving is not being executed in any one of the first mode, the second mode, and the third mode, the process of one routine of this flowchart ends.

When automated driving is being executed in any one of the first mode, the second mode, and the third mode, the occupant detection unit 160 detects the arrangement or the state of occupants on the basis of the occupant image captured by the vehicle interior camera 90 and the vehicle interior sound acquired by the vehicle interior camera 90 (step S102). Moreover, the occupant detection unit 160 determines whether the occupants sitting on the seats 82-1 to 82-5 are talking to each other (step S104). For example, as illustrated in FIG. 7A, when the face of a driver sitting on the seat 82-1, the face of an occupant sitting on the seat 82-2, the face of an occupant sitting on the seat 82-3, the face of an occupant sitting on the seat 82-4, and the face of an occupant sitting on the seat 82-5 are facing each other at least partially and conversation of occupants is acquired by the vehicle interior camera 90, the occupant detection unit 160 determines that the occupants sitting on the seats 82-1 to 82-5 are talking to each other.

When the occupants sitting on the seats 82-1 to 82-5 are not talking to each other, the process of one routine of this flowchart ends. On the other hand, when the occupants sitting on the seats 82-1 to 82-5 are talking to each other, the seat arrangement control unit 162 performs the seat arrangement control of changing at least one of the posture, the position, and the direction of the seats 82-1 to 82-5 according to the arrangement or the state of the occupants detected by the occupant detection unit 160 (step S106). Specifically, as illustrated in FIG. 7B, the seat arrangement control unit 162 changes at least one of the posture, the position, and the direction of the seats 82-1 to 82-5 so that the bodies of the occupants face each other even when at least two of the occupants sitting on the seats 82-1 to 82-5 have their upper bodies not twisted in relation to the lower bodies.

In the examples illustrated in FIGS. 7A and 7B, although the seat arrangement control unit 162 turns the seats 82-1 to 82-5, the seat arrangement control unit 162 may move the seats 82-1 to 82-5, for example, so that the occupants sitting on the seats 82-1 to 82-5 face each other. Moreover, in the examples illustrated in FIGS. 7A and 7B, although the seat arrangement control unit 162 turns the seats 82-1 and 82-2 and turns the seats 82-3 and 82-5, the seat arrangement control unit 162 may turn the seats 82-1 and 82-2 and may not turn the seats 82-3 and 82-5 instead. That is, even when the seat arrangement control unit 162 does not turn the seats 82-3 and 82-5, a state in which the bodies of the occupants sitting on the seats 82-1 to 82-5 face each other is created.

In the examples illustrated in FIGS. 7A and 7B, since the automated driving control unit 100 determines that the first mode of automated driving is being executed in step S100 of FIG. 6, the seat arrangement control unit 162 executes the seat arrangement control for the driver's seat 82-1 in step S106 of FIG. 6. When the automated driving control unit 100 determines that the second mode or the third mode of automated driving is being executed in step S100 of FIG. 6, the seat arrangement control unit 162 does not execute the seat arrangement control for the driver's seat 82-1 in step S106 of FIG. 6.

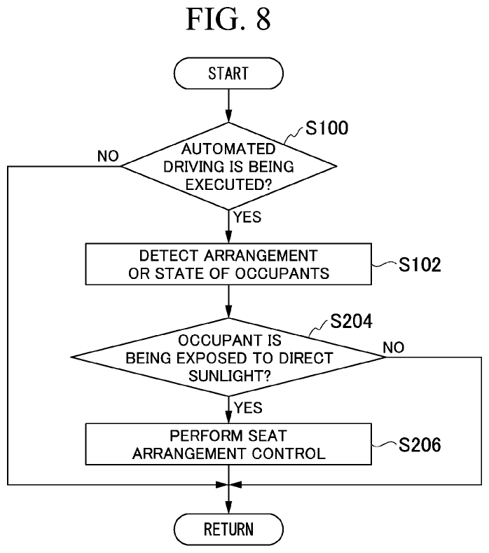

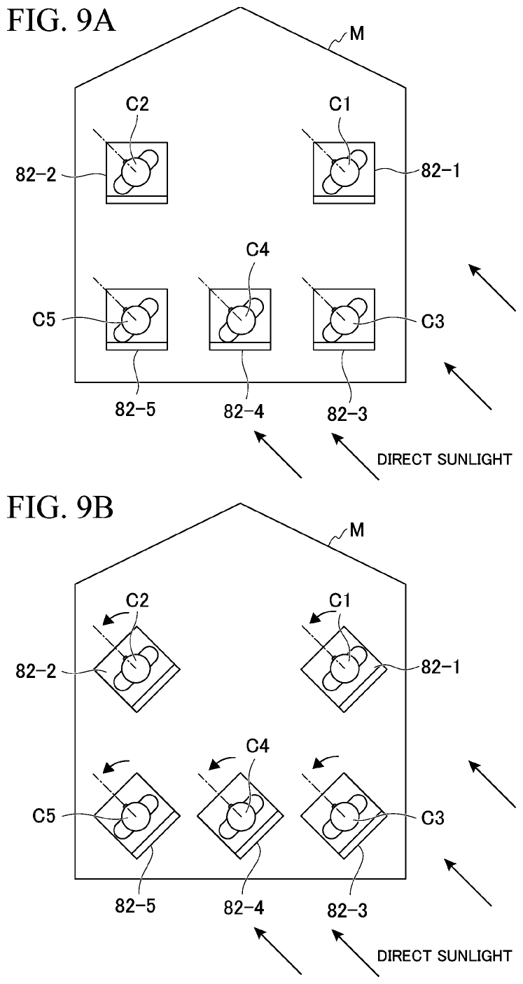

FIG. 8 is a flowchart illustrating another example of the flow of processes executed by the automated driving control unit 100 in order to effectively use a vehicle interior space during automated driving. FIGS. 9A and 9B are diagrams illustrating another example of the arrangement or the state of occupants detected by the occupant detection unit 160 and the seat arrangement control executed in step S206 of FIG. 8.

The process of the flowchart illustrated in FIG. 8 is executed repeatedly at a predetermined period, for example. In steps S100 and S102 of FIG. 8, processes similar to those of steps S100 and S102 of FIG. 6 are executed.

In step S204, the occupant detection unit 160 detects the degree of exposure of an occupant to direct sunlight and determines whether the occupants sitting on the seats 82-1 to 82-5 are exposed to a predetermined amount or more of direct sunlight. For example, as illustrated in FIG. 9A, when the occupants sitting on the seats 82-1 to 82-5 have their upper bodies twisted in relation to the lower bodies so as to avoid direct sunlight exposure, or when the occupants sitting on the seats 82-1 to 82-5 are exposed to direct sunlight, the occupant detection unit 160 determines that the occupants sitting on the seats 82-1 to 82-5 are exposed to a predetermined amount or more of direct sunlight.

When a predetermined amount or more of direct sunlight is not reaching the occupants sitting on the seats 82-1 to 82-5, the process of one routine of this flowchart ends. On the other hand, when a predetermined amount or more of direct sunlight is reaching the occupants sitting on the seats 82-1 to 82-5, the seat arrangement control unit 162 performs the seat arrangement control of changing at least one of the posture, the position, and the direction of the seats 82-1 to 82-5 according to the arrangement or the state of the occupants detected by the occupant detection unit 160 (step S206). Specifically, the seat arrangement control unit 162 changes at least one of the posture, the position, and the direction of the seats 82-1 to 82-5 so as to avoid direct sunlight being exposed to the occupants sitting on the seats 82-1 to 82-5. In the example illustrated in FIG. 9B, the seat arrangement control unit 162 changes at least one of the posture, the position, and the direction of the seats 82-1 to 82-5 so that exposure of direct sunlight can be avoided even when the occupants sitting on the seats 82-1 to 82-5 have their upper bodies not twisted in relation to the lower bodies.

In the examples illustrated in FIGS. 9A and 9B, although the seat arrangement control unit 162 turns the seats 82-1 to 82-5, the seat arrangement control unit 162 may move the seats 82-1 to 82-5, for example, so that exposure of direct sunlight to the occupants sitting on the seats 82-1 to 82-5 is avoided.

In the examples illustrated in FIGS. 9A and 9B, since the automated driving control unit 100 determines that the first mode of automated driving is being executed in step S100 of FIG. 8, the seat arrangement control unit 162 executes the seat arrangement control for the driver's seat 82-1 in step S206 of FIG. 8. When the automated driving control unit 100 determines that the second mode or the third mode of automated driving is being executed in step S100 of FIG. 8, the seat arrangement control unit 162 does not execute the seat arrangement control for the driver's seat 82-1 in step S206 of FIG. 8.

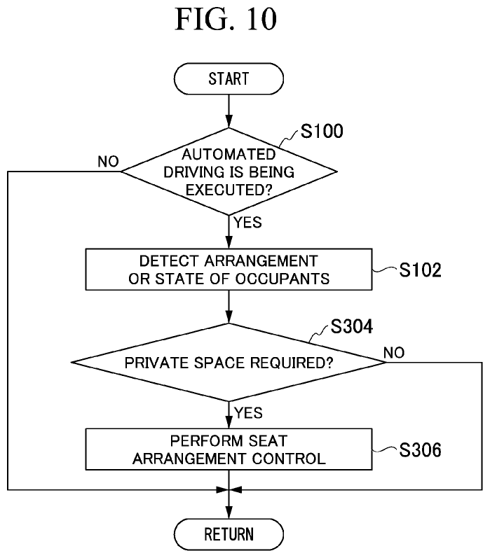

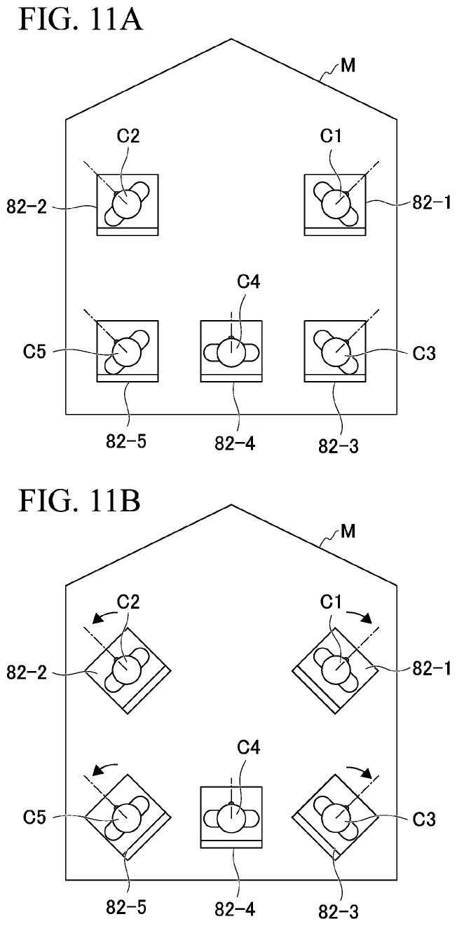

FIG. 10 is a flowchart illustrating another example of the flow of processes executed by the automated driving control unit 100 in order to effectively use a vehicle interior space during automated driving. FIGS. 11A and 11B are diagrams illustrating another example of the arrangement or the state of occupants detected by the occupant detection unit 160 and the seat arrangement control executed in step S306 of FIG. 10.

The process of the flowchart illustrated in FIG. 10 is executed repeatedly at a predetermined period, for example. In steps S100 and S102 of FIG. 10, processes similar to those of steps S100 and S102 of FIG. 6 are executed.

In step S304, the occupant detection unit 160 determines whether the occupants sitting on the seats 82-1 to 82-5 require a private space. For example, as illustrated in FIG. 11A, when the occupants sitting on the seats 82-1 to 82-5 have their upper bodies twisted in relation to the lower bodies so that the bodies of the occupants sitting on the seats 82-1 to 82-5 do not face the body of a neighboring occupant, the occupant detection unit 160 determines that the occupants sitting on the seats 82-1 to 82-5 require their private spaces.

When the occupants sitting on the seats 82-1 to 82-5 are not requiring their private spaces, the process of one routine of this flowchart ends. On the other hand, when the occupants sitting on the seats 82-1 to 82-5 do require their private spaces, the seat arrangement control unit 162 performs the seat arrangement control of changing at least one of the posture, the position, and the direction of the seats 82-1 to 82-5 according to the arrangement or the state of the occupants detected by the occupant detection unit 160 (step S306). Specifically, the seat arrangement control unit 162 changes at least one of the posture, the position, and the direction of the seats 82-1 to 82-5 so that at least two of the occupants sitting on the seats 82-1 to 82-5 do not face each other. In the example illustrated in FIG. 11B, the seat arrangement control unit 162 changes at least one of the posture, the position, and the direction of the seats 82-1 to 82-5 so that the bodies of the occupants sitting on the seats 82-1 to 82-5 do not face the body of a neighboring occupant even when the occupants sitting on the seats 82-1 to 82-5 have their upper bodies not twisted in relation to the lower bodies.

In the examples illustrated in FIGS. 11A and 11B, although the seat arrangement control unit 162 turns the seats 82-1 to 82-5, the seat arrangement control unit 162 may move the seats 82-1 to 82-5, for example, so that the occupants sitting on the seats 82-1 to 82-5 do not face a neighboring occupant.

In the examples illustrated in FIGS. 11A and 11B, since the automated driving control unit 100 determines that the first mode of automated driving is being executed in step S100 of FIG. 10, the seat arrangement control unit 162 executes the seat arrangement control for the driver's seat 82-1 in step S306 of FIG. 10. When the automated driving control unit 100 determines that the second mode or the third mode of automated driving is being executed in step S100 of FIG. 10, the seat arrangement control unit 162 does not execute the seat arrangement control for the driver's seat 82-1 in step S306 of FIG. 10.

According to the vehicle control system of the first embodiment described above, it is possible to effectively use the vehicle interior space since the vehicle control system includes seats provided in a vehicle, an occupant detection unit that detects the arrangement or the state of occupants sitting on the seats, and a seat arrangement control unit that performs seat arrangement control of changing at least one of a posture, a position, and a direction of the seats according to the arrangement or the state of the occupants detected by the occupant detection unit.

### Second Embodiment

A vehicle control system according to a second embodiment is applied to a carpool vehicle system 1. As illustrated in FIG. 2A, the carpool control unit 164 includes an interface control unit 165, a ride candidate determination unit 166, and a carpool fare settlement unit 167. The action plan generation unit 123 generates a target trajectory by taking the processing results of the occupant detection unit 160, the interface control unit 165, the ride candidate determination unit 166, and the like which function as a vehicle interior situation acquisition unit into consideration.

A host vehicle M of the second embodiment outputs information to the vehicle outside by interface control to be described later on the basis of a vehicle interior situation and a predetermined condition, for example. Moreover, the host vehicle M of the second embodiment performs stop control for allowing a ride candidate to get in the vehicle when a person at the vehicle outside is determined to be a ride candidate. Moreover, the host vehicle M of the second embodiment performs carpool fare settlement when an occupant who got in for carpool gets off.

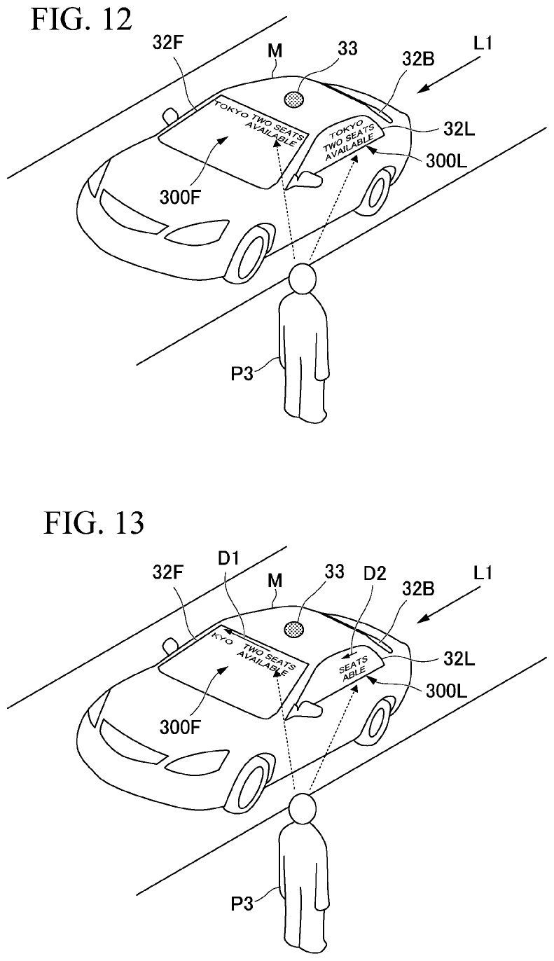

The occupant detection unit 160 acquires the situation in the host vehicle M. The vehicle system 1 of the second embodiment includes a vehicle exterior display 32 and a vehicle interior camera 90. As illustrated in FIG. 12, the vehicle exterior display 32 includes a front-side display 32F, a right-side display, a left-side display 32L, and a rear-side display 32B of the host vehicle M.

The front-side display 32F is a transmissive liquid crystal panel formed in at least a portion of a front glass, for example. The front-side display 32F secures front-side view visible to a driver and displays an image visible to a person present on the front side of the vehicle outside. Moreover, the right-side display, the left-side display 32L, and the rear-side display 32B each are a transmissive liquid crystal panel formed in at least a portion of the glass provided in each direction similarly to the front-side display 32F. The right-side display and the left-side display 32L are formed in the side windows of the rear seat of the host vehicle M. However, there is no limitation thereto, and the displays may be formed in the side windows of the front seat and may be formed in the side windows of the front and rear seats.

Although the vehicle exterior display 32 is formed in at least a portion of the glass of the host vehicle M as described above, the vehicle exterior display 32 may be provided in a body portion outside the host vehicle M instead of this (or in addition to this).

The occupant detection unit 160 acquires the image captured by the vehicle interior camera 90, analyzes the captured image, and determines which seat, the occupant is sitting on among the seats 82-1 to 82-5 in the host vehicle M. For example, the occupant detection unit 160 determines whether a facial region including the facial feature information (for example, the outlines of the eyes, the nose, the mouth, and the face) is present in the captured image. Moreover, when it is determined that the facial region is present, the occupant detection unit 160 determines which seat, the occupant is sitting on among the seats 82-1 to 82-5 on the basis of the position (the central position) of the facial region present in the captured image.

When a load sensor is provided in each of the seats 82-1 to 82-5, and a load value measured by each of the load sensors is equal to or larger than a threshold, the occupant detection unit 160 may determine that an occupant is sitting on the corresponding seat.

The occupant detection unit 160 may analyze a hairstyle and a dress of an occupant, and a shape, a color, and the like of the face from the image captured by the vehicle interior camera 90 and estimate the gender of the occupant on the basis of the analysis result. For example, when an occupant has a long hair and a red-colored lip, the occupant detection unit 160 determines that the occupant is a woman. Moreover, the occupant detection unit 160 may receive the input of information related to the gender of an occupant using the in-vehicle device 31 when the occupant gets in the vehicle. The occupant detection unit 160 may acquire a gender ratio of occupants on the basis of the acquired information related to the genders of the respective occupants.

The occupant detection unit 160 calculates the number of available persons who can get in the host vehicle M on the basis of the number of seats (the number of occupants) on which an occupant is sitting and the total number of seats 82-1 to 82-5.

The occupant detection unit 160 acquires information related to an in-vehicle facility provided in the host vehicle M. The information related to the in-vehicle facility is information related to whether the vehicle includes a charging facility for charging a terminal device and whether a humidifying facility for humidifying the vehicle inside is provided, for example. The information related to the in-vehicle facility may be stored in a storage device (not illustrated) such as a HDD or a flash memory in the automated driving control unit 100. The information related to the in-vehicle facility may be set in advance at the time of factory shipment and may be updated when the facility is attached to or detached from the host vehicle M, for example.

The interface control unit 165 outputs information toward the vehicle outside using at least one of the vehicle exterior display 32 and the vehicle exterior speaker 33. The information is contents such as an image displayed on the vehicle exterior display 32 or sound output from the vehicle exterior speaker 33, for example. The information presented as contents is information for inviting rides, for example. The information presented as contents is information related to the number of persons who can get in the host vehicle M, obtained from the occupant detection unit 160, for example. Moreover, the information presented as contents may be information on the in-vehicle facility or the gender ratio of occupants acquired by the occupant detection unit 160.

The information presented as contents may be information related to a travel plan of the host vehicle M. The information related to a travel plan of the host vehicle M includes at least one of a destination and a route stop of the host vehicle M, for example. By outputting the route stop, a person who goes to the same destination in the route of the host vehicle M can get in the vehicle for carpool. The interface control unit 165 may output the pieces of information presented as contents to the vehicle outside in appropriate combinations.

FIG. 12 is a diagram illustrating an example of contents output toward the vehicle outside. When a person P3 is recognized by the outside recognition unit 121, the interface control unit 165 outputs contents using the vehicle exterior display 32 in such a direction as to be visible from the position of the person P3. In the example of FIG. 12, images 300F and 300L related to the destination and the number of available persons who can get in the host vehicle M are displayed on the front-side display 32F and the left-side display 32L of the host vehicle M traveling in the traveling lane L1. Moreover, the interface control unit 165 may display the images 300F and 300L in a blinking manner and may display the same while changing color from daytime to night-time.

The interface control unit 165 outputs sound of the same content as the information indicated by the image 300L using the vehicle exterior speaker 33. Moreover, the interface control unit 165 may output a music or an alarm that gathers attention using the vehicle exterior speaker 33.

The interface control unit 165 may display character strings indicated by the images 300F and 300L while sequentially moving the character strings from the start of text.

FIG. 13 is a diagram illustrating an example of the movement of the character strings indicated by the images 300F and 300L. In the example of FIG. 13, the interface control unit 165 moves the image 300F displayed on the front-side display 32F in the direction of arrow D1 and moves the image 300L displayed on the left-side display 32L in the direction of arrow D2. The interface control unit 165 displays the images 300F and 300L repeatedly.

The interface control unit 165 controls the moving direction and the display speed of the images 300F and 300L on the basis of the walking direction and the walking speed of a person recognized by the outside recognition unit 121.

For example, when the image 300L is displayed using the left-side display 32L, the interface control unit 165 displays the image 300L while moving the same in a direction opposite to the walking direction of the person P3. Moreover, the speed of moving the display of the image 300L is preferably the same speed as the walking speed of the person P3. In this way, the interface control unit 165 can cause the image 300L to be easily visually recognized by the person P3. Moreover, the person P3 can recognize that the vehicle M is taking notice of the person P3.

When outputting the images 300F and 300L to the person P3, the interface control unit 165 may instruct the action plan generation unit 123 so as to decrease the traveling speed of the host vehicle M on the basis of the traveling speed of the person P3. For example, the interface control unit 165 may cause the host vehicle M to travel at a speed the same as or approximate to the traveling speed of the person P3 so that the images 300F and 300L are easily visually recognized by the person P3.

When a plurality of persons are recognized by the outside recognition unit 121, the interface control unit 165 outputs an image to the vehicle exterior display 32 so as to be visible to a person recognized first. Moreover, the interface control unit 165 may output an image to the vehicle exterior display 32 so as to be visible to a person nearest to the vehicle M.

The predetermined condition for outputting contents toward the vehicle outside is, for example, the conditions related to (1) traveling position of host vehicle M, (2) traveling speed of host vehicle M, (3) operation of person on vehicle outside, and (4) number of available persons in host vehicle M. The interface control unit 165 outputs contents toward the vehicle outside when all of the set conditions among these conditions are satisfied. Hereinafter, the conditions (1) to (4) will be described in detail.

(1) Traveling Position of Host Vehicle M

The interface control unit 165 outputs contents to the vehicle outside when the host vehicle M is traveling in a predetermined segment on the basis of the position information of the host vehicle M recognized by the host vehicle position recognition unit 122, for example. The segment may be set at the time of factory shipment and may be set by an occupant or the like. Moreover, when the segment is set, a set prohibited segment such as an expressway may be set.

(2) Traveling Speed of Host Vehicle M

The interface control unit 165 outputs contents to the vehicle outside when the traveling speed of the host vehicle M is equal to or smaller than a threshold, for example. The threshold may be set in advance for respective roads and may be set by an occupant. In this way, the interface control unit 165 can prevent the output of contents to the vehicle outside in a situation such as an expressway where getting-in of a person is prohibited. Moreover, a person on the vehicle outside can easily watch the contents output to the host vehicle M traveling at a low speed. By outputting contents during a low-speed travel, the host vehicle M can smoothly stop when accepting a ride candidate.

(3) Operation of Person on Vehicle Outside

The interface control unit 165 may output contents to the vehicle outside when it is estimated that a person on the vehicle outside is raising his or her hand. For example, the interface control unit 165 analyzes an image captured by the camera 10 and estimates a person raising his or her hand by pattern matching between an outline shape of a person included in the captured image and a predetermined outline shape of a person raising his or her hand. In this way, the interface control unit 165 can output contents to a person who is highly likely to be a ride candidate.

(4) Number of Available Persons in Host Vehicle M

The interface control unit 165 may output contents to the vehicle outside when the number of available persons in the host vehicle M is 1 or more, for example. In this way, the interface control unit 165 can prevent the output of contents when the vehicle is fully occupied.

In addition to the conditions (1) to (4), the interface control unit 165 may ask an occupant of the host vehicle M whether it is okay to output contents to the vehicle outside using the in-vehicle device 31 of the HMI 30 and may output contents to the vehicle outside when an affirmative input is received from the occupant. In this way, the interface control unit 165 can prevent the output of contents for inviting carpool rides according to the wish of an occupant who does not want a carpool.

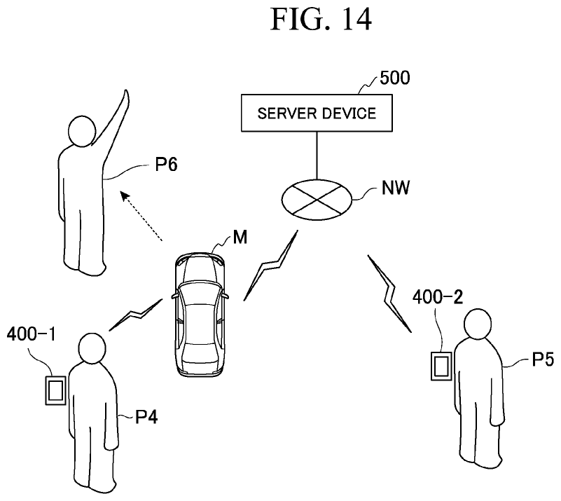

When contents are output to the vehicle outside by the interface control unit 165, the ride candidate determination unit 166 determines whether a person recognized by the outside recognition unit 121 is a ride candidate. FIG. 14 is a diagram for describing the content of ride candidate determination by the ride candidate determination unit 166. The example of FIG. 14 illustrates the host vehicle M, persons P4 to P6, terminal devices 400-1 and 400-2 (hereinafter referred collectively to as a “terminal device 400” except when the respective terminal devices are distinguished from each other) held by the persons P4 and P5, and a server device 500. The host vehicle M, the terminal device 400, and the server device 500 communicate with each other via a network NW. The network NW is a wide area network (WAN) or a local area network (LAN), for example.

The terminal device 400 is a smartphone or a tablet terminal, for example. The terminal device 400 has a function of communicating with surrounding vehicles M using a cellular network, a Wi-Fi network, Bluetooth (registered trademark), DSRC, or the like, or communicating with the server device 500 via a wireless base station.

The server device 500 manages the traveling position, the state, and the like of one or a plurality of vehicles. The server device 500 is one information processing device, for example. Moreover, the server device 500 may be a cloud server including one or more information processing devices.

The ride candidate determination unit 166 determines that a person P4 recognized by the outside recognition unit 121 is a ride candidate when the ride candidate determination unit 166 is notified of information indicating that the person is a ride candidate from the terminal device 400-1 of the person P4 on the vehicle outside, for example. In the example of FIG. 14, the person P4 outputs a signal indicating that the person is a ride candidate to the surroundings using the terminal device 400-1. The surroundings are a communicable range defined by a communication standard. The host vehicle M receives a signal from the terminal device 400-1 with the aid of the communication device 20. The ride candidate determination unit 166 recognizes a person near the host vehicle M with the aid of the outside recognition unit 121 on the basis of the signal received from the terminal device 400-1 and determines that the recognized person P4 is a ride candidate.

The ride candidate determination unit 166 determines that a person recognized by the outside recognition unit 121 is a ride candidate when the ride candidate determination unit 166 is notified of information indicating that the person is a ride candidate from the terminal device 400-2 indirectly via the server device 500. In the example of FIG. 14, a person PS transmits information indicating that the person is a ride candidate and the position information of the terminal device 400-2 to the server device 500 via the network NW using the terminal device 400-2. The server device 500 extracts the host vehicle M travelling nearest to the position of the terminal device 400-2 on the basis of the information received from the terminal device 400-2 and transmits information indicating that the person is a ride candidate and the position information of the terminal device 400-2 to the extracted host vehicle M. The ride candidate determination unit 166 determines that the person PS near the position of the terminal device 400-2 is a ride candidate on the basis of the information received from the server device 500.

The ride candidate determination unit 166 may analyze an image captured by the camera 10, and when it is determined that a person included in the captured image is raising his or her hand, determine that the person is a ride candidate. In the example of FIG. 14, the person P6 is raising his or her hand. Therefore, the ride candidate determination unit 166 determines that the person P6 is a ride candidate by analyzing the image captured by the camera 10.

When there is a ride candidate, the ride candidate determination unit 166 outputs an instruction to stop the host vehicle M near the person to the action plan generation unit 123. The action plan generation unit 123 generates a target trajectory for stopping according to the instruction from the ride candidate determination unit 166 and outputs the generated target trajectory to the travel control unit 141. In this way, it is possible to stop the vehicle M near the ride candidate.

When the host vehicle M is stopped, the interface control unit 165 may output information indicating that the vehicle will stop to the vehicle outside using at least one of the vehicle exterior display 32 and the vehicle exterior speaker 33. Moreover, the interface control unit 165 may output information related to a scheduled position (a scheduled stop position) at which a ride candidate will ride to the vehicle outside using at least one of the vehicle exterior display 32 and the vehicle exterior speaker 33.

For example, when a ride candidate is in a parking and stopping prohibition zone such as a crosswalk or a bus stop, the host vehicle M cannot stop near the ride candidate. Therefore, the interface control unit 165 acquires a scheduled stop position on the basis of the target trajectory generated by the action plan generation unit 123 and presents the acquired information related to the scheduled stop position to the ride candidate using at least one of the vehicle exterior display 32 and the vehicle exterior speaker 33.

When a person determined to be a ride candidate by the ride candidate determination unit 166 is near a crosswalk, the interface control unit 165 displays an image related to a scheduled stop position using the front-side display 32F. The image includes information such as “this vehicle will stop 15 meters ahead”. In this way, the person can easily understand that the host vehicle M stops to pick up the person and the stopping position.

When a plurality of persons ride the host vehicle M, the carpool fare settlement unit 167 calculates the costs for the respective occupants on the basis of conditions such as the number of carpool occupants, a travel segment, a distance, and an actual expense (a fuel expense and a toll). For example, the carpool fare settlement unit 167 divides the total expense by the number of carpool occupants, and each occupant can arrive at a destination with a fewer cost. Moreover, the carpool fare settlement unit 167 may present a settlement result or the like to an occupant using the in-vehicle device 31 when the occupant gets off.

The carpool fare settlement unit 167 may calculate a point for a carpool occupant rather than the amount of money. The calculated amount of money or point may be settled on the spot, and may be transmitted to the server device 500 illustrated in FIG. 14 via the communication device 20.

When the calculated amount of money or point is transmitted to the server device 500, the server device 500 manages the amount of money or the point for respective occupants. In this way, the occupant can settle the amount of money used each month and can obtain a benefit such as using the accumulated point when the occupant uses a carpool or exchanging the point with goods or the like.

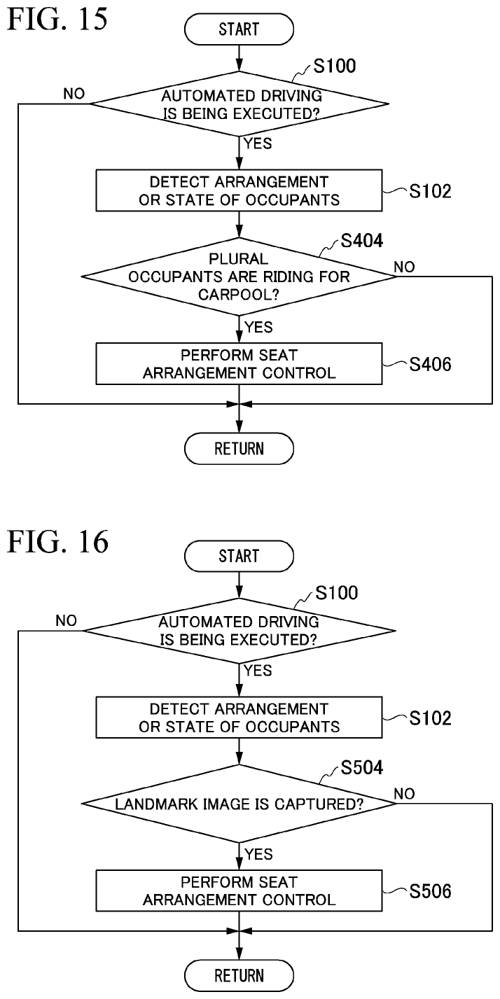

FIG. 15 is a flowchart illustrating another example of the flow of processes executed by the automated driving control unit 100 in order to effectively use a vehicle interior space during automated driving. The process of the flowchart illustrated in FIG. 15 is executed repeatedly at a predetermined period, for example. In steps S100 and S102 of FIG. 15, processes similar to those of steps S100 and S102 of FIG. 6 are executed.

In step S404, the carpool control unit 164 determines whether a plurality of occupants are riding in a carpool.

In a first example of determining whether a plurality of occupants are riding in a carpool, a carpool switch (not illustrated) is provided in the vehicle system 1. An occupant operates the carpool switch when riding in a carpool, the occupant causes the vehicle system 1 to recognize that the person is a carpool occupant. When a plurality of occupants have operated the carpool switch, the carpool control unit 164 determines that a plurality of occupants are riding in a carpool.

In a second example of determining whether a plurality of occupants are riding in a carpool, the image captured by the vehicle interior camera 90 and the vehicle interior sound acquired by the vehicle interior camera 90 are used. When a plurality of occupants have not talked for a predetermined period, the carpool control unit 164 determines that a plurality of occupants are riding in a carpool.

In a third example of determining whether a plurality of occupants are riding in a carpool, the face of an occupant captured by the vehicle interior camera 90 is stored in advance as occupant information in a storage device such as a HDD or a flash memory. When a plurality of faces different from the face of the occupant stored in advance as occupant information is captured by the vehicle interior camera 90, the carpool control unit 164 determines that the faces of the faces of carpool occupants and a plurality of occupants are riding in a carpool.

When it is determined in step S404 that a plurality of occupants are not riding in a carpool, the process of one routine of this flowchart ends. On the other hand, when a plurality of occupants are riding in a carpool, the occupant detection unit 160 determines that at least one of the plurality of occupants requires a private space, the seat arrangement control unit 162 performs the seat arrangement control of changing at least one of the posture, the position, and the direction of the seats 82-1 to 82-5 according to the arrangement or the state of the occupants detected by the occupant detection unit 160 (step S406). Specifically, the seat arrangement control unit 162 changes at least one of the posture, the position, and the direction of the seats 82-1 to 82-5 so that the bodies of the occupants sitting on the seats 82-1 to 82-5 do not face each other. In the example illustrated in FIG. 11B, the seat arrangement control unit 162 changes at least one of the posture, the position, and the direction of the seats 82-1 to 82-5 so that the bodies of the occupants sitting on the seats 82-1 to 82-5 do not face the body of a neighboring occupant even when the occupants sitting on the seats 82-1 to 82-5 have their upper bodies not twisted in relation to the lower bodies.

According to the vehicle control system of the second embodiment described above, it is possible to secure the private spaces of a plurality of carpool occupants in addition to the advantages similar to those of the vehicle control system of the first embodiment.

### Third Embodiment

In a vehicle control system of a third embodiment, the camera 10 functions as an imaging unit that captures an image of the vehicle exterior scene. As illustrated in FIG. 2B, the landmark visual recognition control unit 168 includes a determination unit 169.

The determination unit 169 determines whether a predetermined landmark is present around the host vehicle M on the basis of the position of the host vehicle M. Information indicating the landmark is stored in association with the first map information 54 of the navigation apparatus 50, for example. The determination unit 169 determines whether the position of the host vehicle M specified by the GNSS receiver 51 of the navigation apparatus 50 has entered a visible region of the landmark by referring to the first map information 54 of the navigation device 50. The visible region of the landmark is a region determined in advance as a place in which it is possible to watch the landmark from the vehicle inside. For example, the visible region of the landmark is an area having a predetermined shape around the set landmark. The determination unit 169 determines that the landmark is present around the host vehicle M when the position of the host vehicle M has entered the visible region of the landmark. The determination unit 169 determines that the landmark is present around the host vehicle M when the position of the host vehicle M has moved into the inner side of the visible region of the landmark from the outside.

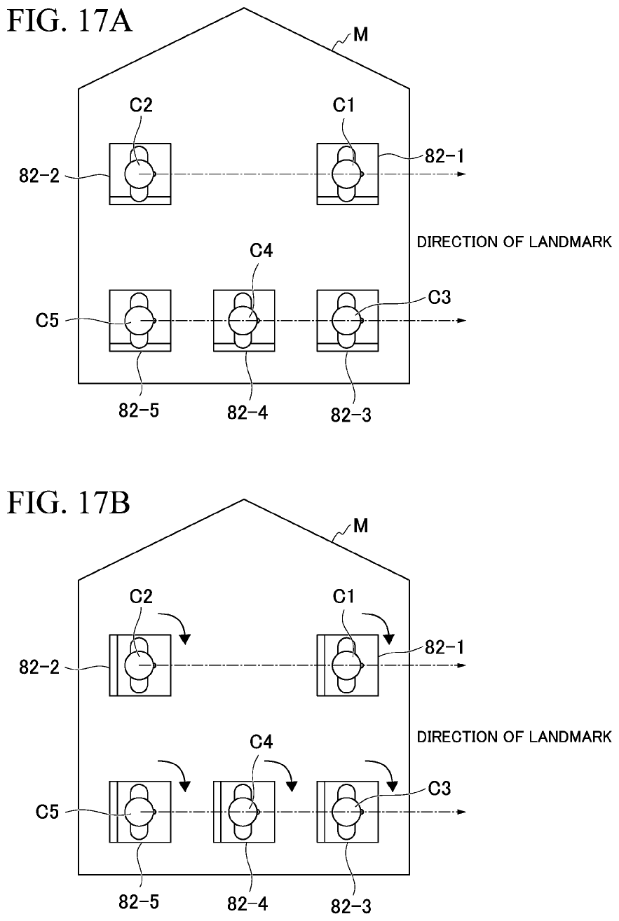

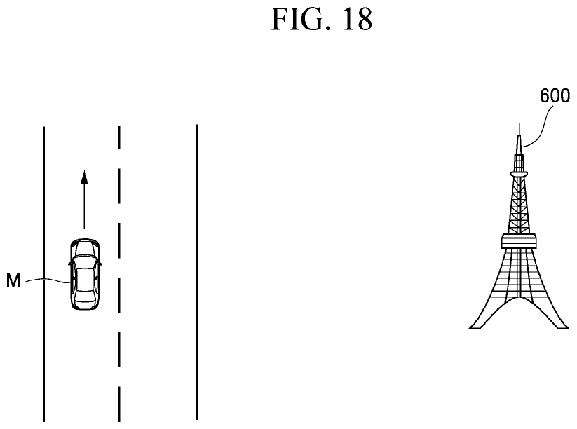

FIG. 16 is a flowchart illustrating another example of the flow of processes executed by the automated driving control unit 100 in order to effectively use a vehicle interior space during automated driving. FIGS. 17A and 17B are diagrams illustrating another example of the arrangement or the state of occupants detected by the occupant detection unit 160 and the seat arrangement control executed in step S506 of FIG. 16.

The process of the flowchart illustrated in FIG. 16 is executed repeatedly at a predetermined period, for example. In steps S100 and S102 of FIG. 16, processes similar to those of steps S100 and S102 of FIG. 6 are executed.

In step S504, the landmark visual recognition control unit 168 determines whether a landmark is included in the vehicle exterior scene captured by the camera 10 functioning as an imaging unit. FIG. 18 is a diagram illustrating an example of a positional relation between the host vehicle M and a landmark 600 when a landmark is included in a vehicle exterior scene captured by a camera 10.

When the landmark 600 is not included in the vehicle exterior scene captured by the camera 10, the process of one routine of this flowchart ends. On the other hand, when the landmark 600 is included in the vehicle exterior scene captured by the camera 10, the seat arrangement control unit 162 performs the seat arrangement control of changing at least one of the posture, the position, and the direction of the seats 82-1 to 82-5 according to the arrangement or the state of the occupants detected by the occupant detection unit 160 (step S506). Specifically, the seat arrangement control unit 162 changes at least one of the posture, the position, and the direction of the seats 82-1 to 82-5 so that the bodies of the occupants sitting on the seats 82-1 to 82-5 face the landmark 600. In the example illustrated in FIG. 17B, the seat arrangement control unit 162 changes at least one of the posture, the position, and the direction of the seats 82-1 to 82-5 so that the bodies of the occupants sitting on the seats 82-1 to 82-5 face the landmark 600 even when the occupants sitting on the seats 82-1 to 82-5 have their upper bodies not twisted in relation to the lower bodies.

In the examples illustrated in FIGS. 17A and 17B, although the seat arrangement control unit 162 turns the seats 82-1 to 82-5, the seat arrangement control unit 162 may move the seats 82-1 to 82-5, for example, so that the bodies of the occupants sitting on the seats 82-1 to 82-5 face the landmark 600 instead.

In the examples illustrated in FIGS. 17A and 17B, since the automated driving control unit 100 determines that the first mode of automated driving is being executed in step S100 of FIG. 16, the seat arrangement control unit 162 executes the seat arrangement control for the driver's seat 82-1 in step S506 of FIG. 16. When the automated driving control unit 100 determines that the second mode or the third mode of automated driving is being executed in step S100 of FIG. 16, the seat arrangement control unit 162 does not execute the seat arrangement control for the driver's seat 82-1 in step S506 of FIG. 16.

According to the vehicle control system of the third embodiment described above, it is possible to allow occupants to easily watch a landmark in addition to the advantages similar to those of the vehicle control system of the first embodiment.

While modes for carrying out the present invention have been described using embodiments, the present invention is not limited to these embodiments, but various modifications and replacements can be made without departing from the spirit of the present invention.

### REFERENCE SIGNS LIST

1 Vehicle system

10 Camera

12 Radar device

14 Finder

16 Object recognition device

20 Communication device

30 HMI

31 In-vehicle device

32 Vehicle exterior display

33 Vehicle exterior speaker

50 Navigation apparatus

51 GNSS receiver

52 Navigation HMI

53 Route determination unit

54 First map information

60 MPU

61 Recommended lane determination unit

62 Second map information

70 Vehicle sensor

80 Driving operator

82-1, 82-2, 82-3, 82-4, 82-5 Seat

90 Vehicle interior camera

100 Automated driving control unit

120 First control unit

121 Outside recognition unit

122 Host vehicle position recognition unit

123 Action plan generation unit

140 Second control unit

141 Travel control unit

160 Occupant detection unit

162 Seat arrangement control unit

164 Carpool control unit

165 Interface control unit

166 Ride candidate determination unit

167 Carpool fare settlement unit

168 Landmark visual recognition control unit

169 Determination unit

200 Travel drive force output device

210 Brake device

220 Steering device

400, 400-1, 400-2 Terminal device

500 Server device

600 Landmark

M Host vehicle

NM Network

What is claim is:

1.-9. (canceled)

10. A vehicle control system comprising:
seats provided in a vehicle;
an occupant detection unit that detects an arrangement or a state of occupants in a vehicle cabin of the vehicle; and
a seat arrangement control unit that performs seat arrangement control of changing at least one of a posture, a position, and a direction of the seats according to the arrangement or the state of the occupants detected by the occupant detection unit, wherein
the occupant detection unit determines that at least one of a plurality of occupants requires a private space when a plurality of occupants are riding in a carpool.

11. The vehicle control system according to claim 10, further comprising:
an automated driving controller that executes automated driving of automatically controlling at least one of acceleration/deceleration and steering of the vehicle, wherein
the seat arrangement control unit performs the seat arrangement control when automated driving is executed by the automated driving controller.

12. The vehicle control system according to claim 10, wherein
the seat arrangement control unit performs the seat arrangement control so that the bodies of at least two of a plurality of occupants face each other when a state in which a plurality of occupants are talking to each other is detected by the occupant detection unit.

13. The vehicle control system according to claim 10, wherein
the occupant detection unit can detect a degree of exposure of an occupant to direct sunlight, and
the seat arrangement control unit performs the seat arrangement control so as to avoid direct sunlight exposure of the occupant when a state in which the occupant is exposed to a predetermined amount or more of direct sunlight is detected by the occupant detection unit.

14. The vehicle control system according to claim 10, wherein
the seat arrangement control unit performs the seat arrangement control so that bodies of at least two of a plurality of occupants do not face each other when the occupant detection unit determines that a plurality of occupants require a private space.

15. The vehicle control system according to claim 10, further comprising:
an imaging unit that captures a vehicle exterior scene, wherein
the seat arrangement control unit performs the seat arrangement control so that bodies of occupants face a landmark when the landmark is included in the vehicle exterior scene captured by the imaging unit.

16. A vehicle control method for causing a computer mounted in a vehicle including seats to execute:
detecting an arrangement or a state of occupants in a vehicle cabin of the vehicle;
performing seat arrangement control of changing at least one of a posture, a position, and a direction of the seats according to the arrangement or the state of the occupants; and
determining that at least one of a plurality of occupants requires a private space when a plurality of occupants is riding in a carpool.

17. A non-transitory computer-readable recording medium recording a vehicle control program for causing a computer mounted in a vehicle including seats to execute:
detecting an arrangement or a state of occupants in a vehicle cabin of the vehicle;
performing seat arrangement control of changing at least one of a posture, a position, and a direction of the seats according to the arrangement or the state of the occupants; and
determining that at least one of a plurality of occupants requires a private space when a plurality of occupants is riding in a carpool.
